(19) United States
(12) Patent Application Publication
(10) Pub. No.: US 2010/0144273 A1
(43) Pub. Date: Jun. 10, 2010

(54) PORTABLE DEVICE

(76) Inventors: Yusuke SEKIKAWA, Sagamihara-shi (JP); Tsugumoto Kosugiyama, Tokyo (JP); Toshihiro Ogata, Tokyo (JP)

Correspondence Address: STRAUB & POKOTYLO, 788 Shrewsbury Avenue, TINTON FALLS, NJ, 07724, US

(21) Appl. No.: 12/620,883

(22) Filed: Nov. 18, 2009

(30) Foreign Application Priority Data
Dec. 5, 2008 (JP) 2008-311550

(51) Int. Cl. H04B 7/00; H04B 1/38

(52) U.S. Cl. 455/41.2; 455/73

(57) ABSTRACT

A communication control unit performs communications with an external device via a first wireless communication unit of which communication distance is short and which is capable of performing high-speed communications or a second wireless communication unit of which communication distance is long compared with the first wireless communication unit and which is capable of performing low-speed communications. A communication state judging unit judges a communication state of the communications with the external device via the first wireless communication unit or the second wireless communication unit. The communication control unit performs switching between the communications with the external device via the first wireless communication unit and the communications with the external device via the second wireless communication unit based on the communication state judged by the communication state judging unit and/or a transmission data amount to be transmitted to the external device.

### CROSS-REFERENCE TO RELATED APPLICATIONS

This application is based upon and claims the benefit of priority from Japanese Patent Application No. 2008-311550, filed on Dec. 5, 2008, the entire contents of which are incorporated herein by reference.

### BACKGROUND OF THE INVENTION

1. Field of the Invention

The present invention relates to a portable device.

2. Description of the Related Art

It has been conventionally performed to connect a digital camera to an external device such as a personal computer (PC) and transmit an image captured by the digital camera to the external device. Japanese Patent Application Laid-open No. 2005-286654 discloses a technology in which a plurality of communication interfaces provided in a digital camera is operated simultaneously to transmit data for improving a communication rate.

### SUMMARY OF THE INVENTION

A portable device according to an aspect of the present invention includes a first wireless communication unit of which communication distance is short, the first wireless communication unit being capable of performing high-speed communications; a second wireless communication unit of which communication distance is long compared with the first wireless communication unit, the second wireless communication unit being capable of performing low-speed communications; a communication control unit that performs communications with an external device via any one of the first wireless communication unit and the second wireless communication unit and controls at least a transmission of data to the external device; and a communication state judging unit that judges a communication state of the communications with the external device via any one of the first wireless communication unit and the second wireless communication unit, wherein the communication control unit performs switching between the communications with the external device via the first wireless communication unit and the communications with the external device via the second wireless communication unit based on at least one of the communication state judged by the communication state judging unit and a transmission data amount to be transmitted to the external device in order to control the transmission of data to the external device.

A portable device according to another aspect of the present invention includes a wireless communication unit that comprises a first wireless communication processing unit of which communication distance is short, the first wireless communication unit being capable of performing high-speed communications and a second wireless communication processing unit of which communication distance is long compared with the first wireless communication unit, the second wireless communication unit being capable of performing low-speed communications; a communication control unit that performs communications with an external device via any one of the first wireless communication processing unit and the second wireless communication processing unit and controls at least a transmission of data to the external device; and a communication state judging unit that judges a communication state of the communications with the external device via any one of the first wireless communication processing unit and the second wireless communication processing unit, wherein the communication control unit performs switching between the communications with the external device via the first wireless communication processing unit and the communications with the external device via the second wireless communication processing unit based on at least one of the communication state judged by the communication state judging unit and a transmission data amount to be transmitted to the external device in order to control the transmission of data to the external device.

A portable device still another aspect of the present invention includes a wireless communication unit that performs a data transmission and reception with an external device that is brought to close to the portable device; and a communication control unit that performs a communication with the external device via the wireless communication unit and controls at least a transmission of data to the external device, wherein the wireless communication unit includes a first communication mode, in which a communication distance is short and high-speed communications are performed, and a second communication mode, in which a communication distance is long and low-speed communications are performed, and the communication control unit switches a communication mode between the first communication mode and the second communication mode based on a usage state of the portable device.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic perspective view showing a front surface side of a digital camera;

FIG. 2 is a schematic perspective view showing a back surface side of the digital camera;

FIG. 3 is a schematic diagram illustrating a state in which the digital camera communicates with a partner device;

FIG. 4 is another schematic diagram illustrating a state in which the digital camera communicates with a partner device;

FIG. 5 is a table explaining a principle of a communication between the digital camera and a partner device;

FIGS. 6A and 6B are schematic diagrams explaining a content of data transmitted and received between the digital camera and a partner device;

FIGS. 7A and 7B are other schematic diagrams explaining a content of data transmitted and received between the digital camera and a partner device;

FIGS. 8A to 8C are still other schematic diagrams explaining a content of data transmitted and received between the digital camera and a partner device;

FIG. 9 is a block diagram illustrating an example of an internal configuration of a relevant portion of the digital camera;

FIG. 10 is a flowchart illustrating a procedure of a basic process performed by the digital camera;

FIG. 11 is a flowchart illustrating a detailed process procedure of a shooting mode process;

FIG. 12 is a flowchart illustrating a detailed process procedure of a playback mode process;

FIG. 13 is a flowchart illustrating a detailed process procedure of a collective transmission process;

FIG. 14 is a schematic diagram illustrating a state in which a digital camera of a modified example communicates with another digital camera as a partner device;

FIG. 15 is a schematic perspective view showing a front surface side of the digital camera of the modified example;

FIG. 16 is a block diagram illustrating an example of an internal configuration of a relevant portion of the digital camera of the modified example;

FIG. 17 is a schematic diagram explaining a principle of a low-speed wireless communication process performed by a low-speed wireless communication processing unit; and

FIG. 18 is a schematic diagram explaining a principle of a high-speed wireless communication process performed by a high-speed wireless communication processing unit.

### DETAILED DESCRIPTION OF THE PREFERRED EMBODIMENTS

Exemplary embodiments of the present invention are explained in detail below with reference to the accompanying drawings. The present invention is not limited to the embodiments. Same components are given the same reference numerals in each drawing.

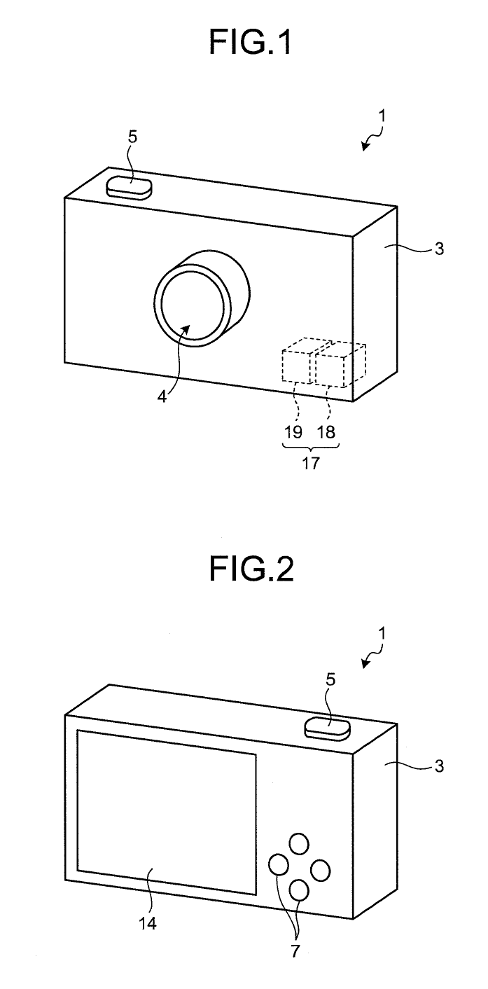

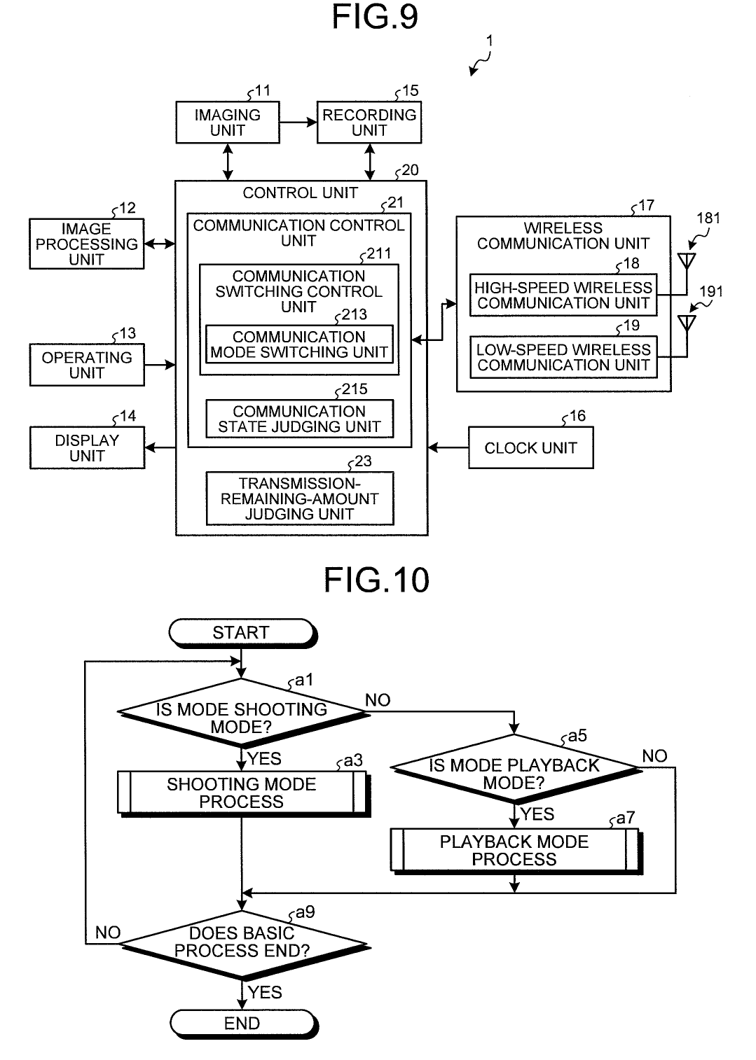

FIG. 1 is a schematic perspective view showing a front surface side of a digital camera 1 to which a portable device of the present invention is applied. FIG. 2 is a schematic perspective view showing a back surface side of the digital camera 1. As shown in FIG. 1, the digital camera 1 includes an imaging lens 4 provided on the front surface of a camera body 3 and an imaging unit 11 (see FIG. 9) inside the camera body 3 for imaging a subject image incident through the imaging lens 4. Moreover, the digital camera 1 includes a release switch 5 for instructing a shooting timing on the upper surface of the camera body 3. Furthermore, the digital camera 1 includes a display unit 14 that displays various screens and a plurality of button switches 7, to which specific functions for inputting various operations such as a power-on or a mode selection are allocated, on the back surface of the camera body 3.

When the digital camera 1 is turned on and a shooting mode is selected, the digital camera 1 becomes a state ready for shooting. In the shooting mode, a subject image incident through the imaging lens 4 is displayed on the display unit 14 in real time as a live view image, so that a user captures a still image or a moving image by pressing the release switch 5 while checking the live view image. A user can also switch an operation mode of the digital camera 1 to a playback mode and enjoy a captured still image or a moving image that by displaying (playing) it on the display unit 14.

As shown in FIG. 1, a high-speed wireless communication unit 18 as a first wireless communication unit and a low-speed wireless communication unit 19 as a second wireless communication unit are incorporated as a wireless communication unit 17 at predetermined positions in the camera body 3 of the digital camera 1. The wireless communication unit 17 performs wireless communications with an external device (hereinafter, the external device as a communication partner is referred to as a partner device) such as another digital camera 1, a PC, a cellular phone, or a television set. The high-speed wireless communication unit 18 has a short communication distance and can perform a high-speed and large-capacity communication compared with the low-speed wireless communication unit 19. For example, the high-speed wireless communication unit 18 has a communication distance as short as about 3 cm. The low-speed wireless communication unit 19 has a relatively long communication distance of 10 cm or longer. The high-speed wireless communication unit 18 and the low-speed wireless communication unit 19 are arranged at appropriate positions in the camera body 3 so that the antennas thereof are oriented toward the exterior facing side. A partner device has the similar configuration to the high-speed wireless communication unit 18 and the low-speed wireless communication unit 19 of the wireless communication unit 17 for performing communications with the digital camera 1.

In the communications by the high-speed wireless communication unit 18, the communication distance is short, so that the high-speed wireless communication units may be out of the communication range if the position with respect to a partner device is displaced. Therefore, when data transmission/reception is performed with a partner device by performing communications by the high-speed wireless communication unit 18, the antennas of the digital camera and the partner device need to be arranged close to each other until finishing the data transmission/reception. Thus, for example, in communications between portable devices such as digital cameras, i.e., when a user brings the portable devices in hand close to each other, the communication may become unstable due to displacement, so that data transmission/reception is easy to fail. To solve the problem, at least the high-speed wireless communication unit 18 is preferably arranged at the corner portion of the device casing. In the example shown in FIG. 1, the high-speed wireless communication unit 18 is arranged at one corner portion on the bottom surface side of the camera body 3. With this arrangement, a user can easily position the digital camera 1 with respect to a partner device when performing communications via the high-speed wireless communication unit 18, enabling to suppress communication failure due to displacement.

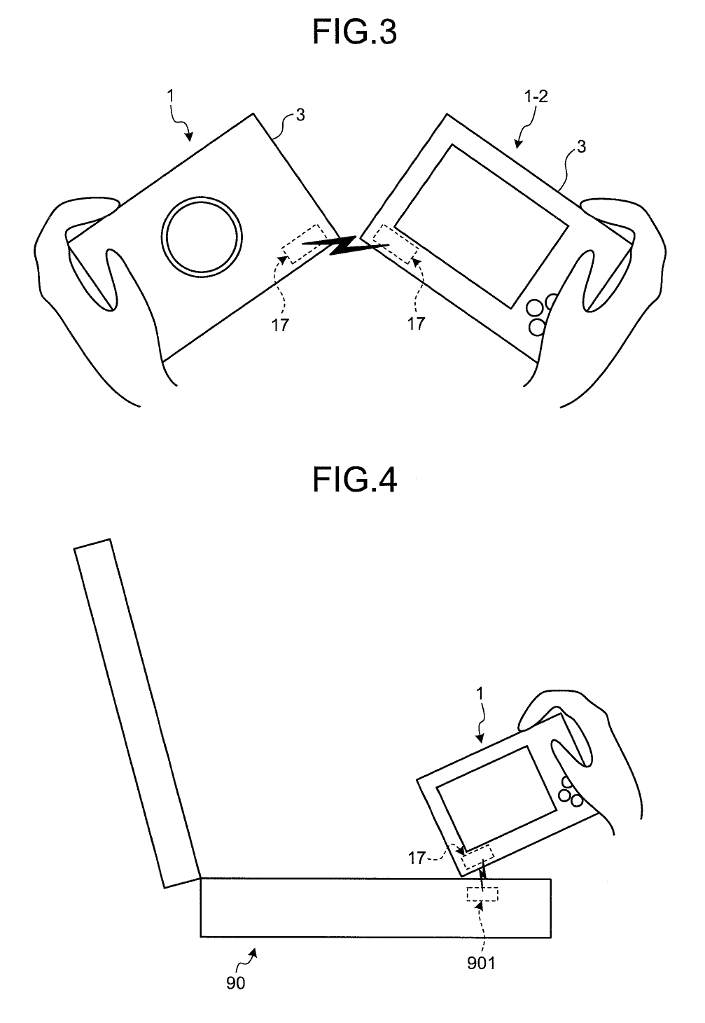

FIG. 3 is a schematic diagram illustrating a state in which the digital camera 1 communicates with another digital camera 1-2 as a partner device. As shown in FIG. 3, when the camera bodies 3 of the digital camera 1 and the digital camera 1-2 are brought close to each other so that the respective wireless communication units 17 (specifically, respective high-speed wireless communication units 18 or respective low-speed wireless communication units 19) are within respective communication coverage ranges, the communication therebetween is established.

FIG. 4 is a schematic diagram illustrating a state in which the digital camera 1 communicates with a PC (laptop computer) 90 as a partner device. A wireless communication unit 901 is incorporated in the PC 90. The wireless communication unit 901 includes a high-speed wireless communication unit capable of communicating with the high-speed wireless communication unit 18 and a low-speed wireless communication unit capable of communicating with the low-speed wireless communication unit 19. The high-speed wireless communication unit and the low-speed wireless communication unit are arranged so that the antennas thereof are arranged on the side of a keyboard face. When the digital camera 1 and the PC 90 are brought close to each other so that the corresponding wireless communication units are within the communication coverage range, the communication therebetween is established.

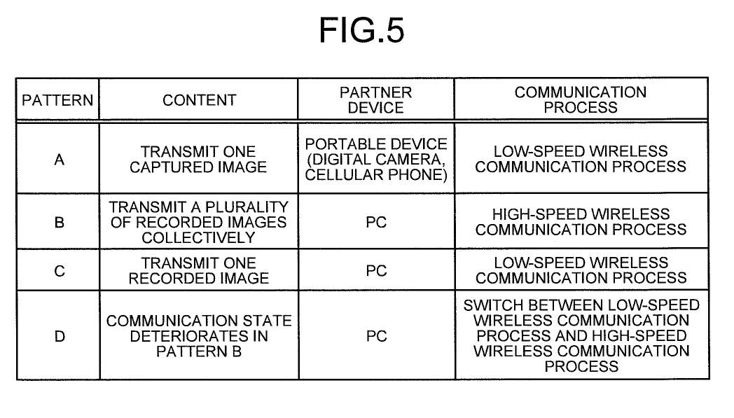

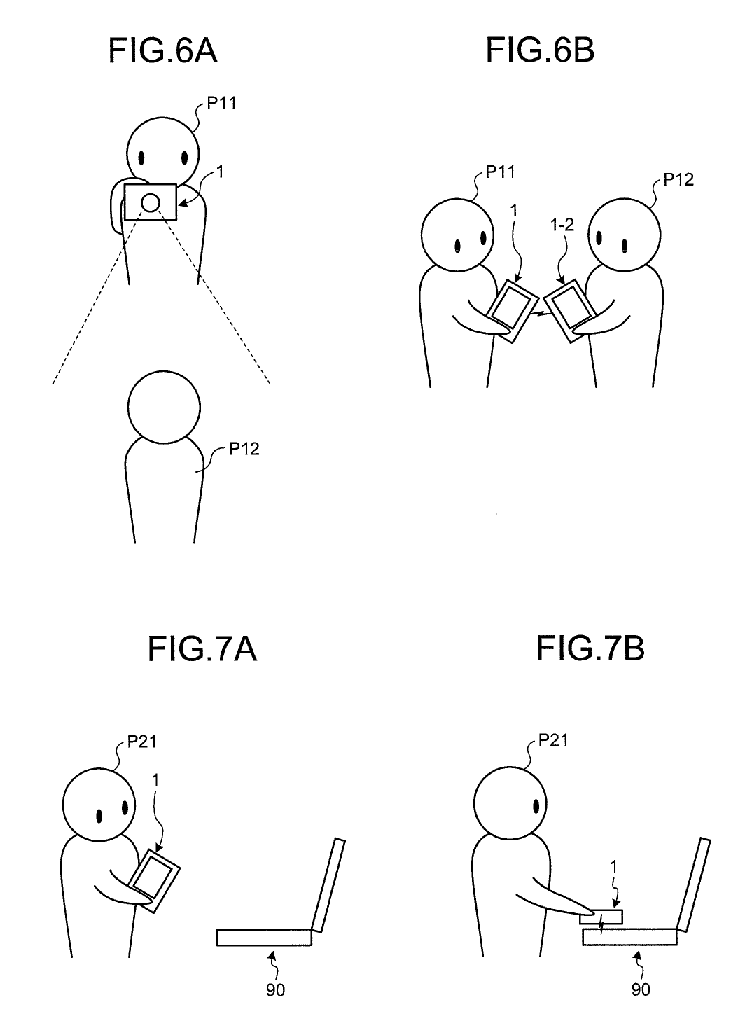

The principle of the communication between the digital camera 1 according to the present embodiment and a partner device is explained. FIG. 5 is a table explaining the principle of the communication between the digital camera 1 and a partner device. FIGS. 6A to 8C are schematic diagrams explaining a content of data transmitted and received between the digital camera 1 and a partner device.

In the present embodiment, as a first example, a case is considered in which a captured image is transmitted to a partner device immediately after captured in the shooting mode, i.e., the usage state of the digital camera 1 is considered in which a portable-type device (portable device) such as another digital camera or a cellular phone is used as the partner device (pattern A in FIG. 5). For example, as shown in FIGS. 6A and 6B, a user P11 switches the mode of the digital camera 1 to the shooting mode and captures an image of a friend (a person P12) (see FIG. 6A). Then, immediately thereafter, the communication is established between the digital camera 1 and the partner device, such as the digital camera 1-2, of the person P12 to transmit the captured image to the digital camera 1-2 (see FIG. 6B).

As a second example, a case is considered in which a plurality of images recorded in the digital camera 1 is collectively transmitted to a partner device in the playback mode, i.e., the usage state of the digital camera 1 is considered in which a stationary device such as a PC having a large capacity hard disk is used as the portable device (pattern B in FIG. 5). For example, as shown in FIGS. 7A and 7B, a user P21 selects all or part of the recorded images in the digital camera 1 while browsing them in the playback mode (see FIG. 7A). Then, the user P21 transmits the images to the partner device, such as the PC (laptop computer) 90 of the user P21, for backup (see FIG. 7B).

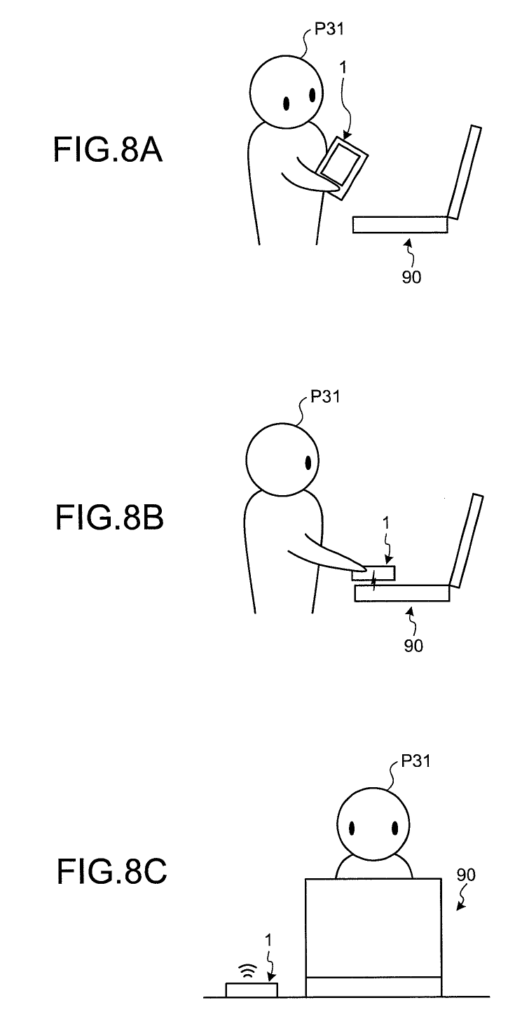

As a third example, a case is considered in which one image recorded in the digital camera 1 is transmitted to a partner device in the playback mode (pattern C in FIG. 5). In this case also, the usage state of the digital camera 1 is considered in which a stationary device such as a PC having a large capacity hard disk is used as the portable device; however, the transmission data amount is small compared with the case of the pattern B. For example, a case is considered in which a user pastes an image captured by the digital camera 1 onto a blog published on the Internet by the user. More specifically, as shown in FIGS. 8A to 8C, a user P31 selects one recorded image in the digital camera 1 while browsing the recorded images in the playback mode (see FIG. 8A), and transmits the recorded image to the partner device such as the PC 90 (see FIG. 8B). In this case, it is considered that the user P31 repeats transmitting a captured image while editing a blog on the PC 90. Specifically, as shown in FIG. 8C, for example, the user P31 operates the PC 90 while placing the digital camera 1 on a desk, and operates the digital camera 1 again as shown in FIG. 8A when needed to select a different recorded image. Then, as shown in FIG. 8B, the newly selected recorded image is transmitted to the PC 90.

As in the case shown in FIGS. 7A and 7B, when the communication is established with the partner device in the playback mode and a plurality of pieces of image data is collectively transmitted to the partner device, high-speed transmission is required. When collectively transmitting a plurality of pieces of image data, a shorter transmission time gives a user less stress. In contrast, as in the case shown in FIGS. 6A and 6B, or the case shown in FIGS. 8A to 8C, when the communication is established with the partner device in the shooting mode or the playback mode and one piece of image data is transmitted, reliable transmission (stability) is required rather than the high-speed. In other words, image data transmitted one by one is used for operation on the PC such as for giving the image data to a friend, so that the image data is desired to be surely transmitted when a transmission instruction is input. Moreover, transmitting image data for one image is sufficient and a large capacity communication is not needed.

Therefore, in the digital camera 1 in the present embodiment, in the case of the pattern B in which a plurality of pieces of image data is collectively transmitted as shown in FIG. 5, specifically, in the case where the collective transmission instruction is made in the playback mode, it is considered that the usage state of the digital camera 1 is the usage state in which a stationary device is used as a portable device and the transmission data amount is large, and data transmission/reception is performed with the partner device by communicating with the partner device by the high-speed wireless communication unit 18 (high-speed wireless communication process). With this communication, a plurality of pieces of selected image data can be transmitted in a short time to the partner device with which the communication is established. In contrast, in the case of the pattern A in which image data is transmitted one by one, specifically, in the case where the transmission instruction is made after the shooting process in the shooting mode, it is considered that the usage state of the digital camera 1 is the usage state in which a stationary device is used as a portable device, and data transmission/reception is performed with the partner device by communicating with the partner device by the low-speed wireless communication unit 19 (low-speed wireless communication process). Similarly, in the case of the pattern C, specifically, in the case where it is instructed to transmit image data one by one, it is considered that the usage state of the digital camera 1 is the usage state in which a stationary device is used as a portable device and the transmission data amount is small, and data transmission/reception is performed with the partner device by communicating with the partner device by the low-speed wireless communication unit 19 (low-speed wireless communication process). In the communication by the low-speed wireless communication unit 19, the communication distance is relatively long, so that the communication coverage range is wide compared with the case of the communication by the high-speed wireless communication unit 18, and a stable communication can be performed even if the partner device is far from the digital camera 1 to a certain degree. Therefore, image data as a transmission subject can be surely transmitted when a transmission instruction is input.

In the present embodiment, in addition to the patterns A to C, as shown in FIG. 5, a pattern D is considered in which the communication state deteriorates in the case of the pattern B in which a plurality of recorded images is collectively transmitted to a partner device. If the communication state by the high-speed wireless communication unit 18 is not good, the communication is switched from the communication by the high-speed wireless communication unit 18 to the communication by the low-speed wireless communication unit 19 to transmit data (switching between the high-speed wireless communication process and the low-speed wireless communication process).

Moreover, the digital camera 1 in the present embodiment switches the communication mode while performing the communication by the low-speed wireless communication unit 19.

For example, as explained in FIGS. 8A to 8C, in the case of repeating transmission of recorded images one by one in the playback mode, an instruction for transmitting another recorded image may be input continuously. Practically, a next transmission instruction may be input immediately or may not be input for a long time. Therefore, if the low-speed wireless communication unit 19 keeps transmitting a radio wave even after transmitting image data for one image, the power consumption increases. For example, when the digital camera 1 is placed distant from the PC 90 as a partner device as shown in FIG. 8C, if the low-speed wireless communication unit 19 of the digital camera 1 performs a constant communication and keeps transmitting a radio wave continuously, the power consumption increases.

Therefore, for example, in the communication by the low-speed wireless communication unit 19, the communication mode when the communication is first started is set to a constant communication mode. Then, when the communication state suddenly changes and the communication is cut off during the communication by the low-speed wireless communication unit 19, the communication mode is switched to an intermittent communication mode. Alternatively, when a predetermined time elapses after a last data transmission/reception with a partner device, the communication mode is switched to the intermittent communication mode.

A radio wave is always transmitted for performing the communication in the constant communication mode, so that the digital camera 1 can communicate with a partner device with high response; however, the power consumption in the communication is large. In contrast, in the intermittent communication mode, because the communication is performed by transmitting a radio wave at predetermined time intervals, the power consumption can be suppressed compared with the constant communication mode although the response is low. Therefore, the communication with a partner device can be performed while balancing the response and the power consumption in the communication by switching the communication mode between the constant communication mode and the intermittent communication mode. If the transmission of a radio wave by the low-speed wireless communication unit 19 is stopped after transmission of data, the power consumption can be further decreased. In this case, however, a transmission instruction needs to be input every time a recorded image to be transmitted is selected to start the communication, so that it is troublesome for a user.

FIG. 9 is a block diagram illustrating an example of an internal configuration of a relevant portion of the digital camera 1. As shown in FIG. 9, the digital camera 1 includes the imaging unit 11, an image processing unit 12, an operating unit 13, the display unit 14, a recording unit 15, a clock unit 16, the wireless communication unit 17, and a control unit 20.

The imaging unit 11 includes an imaging element, such as a charge coupled device (CCD) or a complementary metal oxide semiconductor (CMOS), which photoelectrically converts a subject image incident through the imaging lens 4 and outputs an analog electric signal. The imaging unit 11 converts an analog electric image from the imaging element into a digital electric signal and outputs image data.

The image processing unit 12 performs various image processing on the image data output from the imaging unit 11 and performs a process of converting to image data appropriate for recording or display. For example, when recording image data of a captured image, or when displaying recorded image data, the image processing unit 12 performs a compression process or an extension process on the image data based on the joint photographic experts group (JPEG) system or the like.

The operating unit 13 receives various operations by a user such as an instruction for a shooting timing (shooting instruction), switching of the operation mode of the digital camera 1 such as the shooting mode and the playback mode, a transmission instruction for data to a partner device, and a setting of shooting conditions, and notifies the control unit 20 of an operation signal. The operating unit 13 includes the release switch 5 and the button switches 7.

The display unit 14 displays a still image or a moving image captured by the digital camera 1, a live view image, various pieces of setting information of the digital camera 1, and the like, and is constructed by a display device such as a liquid crystal display (LCD) or an electroluminescence (EL) display. On the display unit 14, a live view image is redrawn, for example, in every frame and is continuously displayed in a moving image manner in the shooting mode, and a still image or a moving image captured by the digital camera 1 is displayed in the playback mode.

The recording unit 15 is constructed by an information recording medium such as various integrated circuit memories such as a read only memory (ROM) (for example, an updatable and recordable flash memory) and a random access memory (RAM), and a hard disk or a memory card built in the digital camera 1 or connected with a data communication terminal, or a reading/writing device thereof. The recording unit 15 can be a recording device appropriately employed depending on the intended use. The recording unit 15 stores therein various camera programs for operating the digital camera 1 and realizing various functions included in the digital camera 1, data used when the camera programs are executed, and the like. The camera program includes a computer program for causing the control unit 20 to function as a communication control unit 21 and a transmission-remaining-amount judging unit 23. Moreover, the recording unit 15 records therein image data of images captured by the digital camera 1 as recorded images, image data, for example, received from a different digital camera as a partner device by communicating with the different digital camera, and the like.

The clock unit 16 is for counting date and time. The shooting date and time of an image are specified by the current time counted by the clock unit 16, and image data of the captured image is recorded in the recording unit 15 as a recorded image together with the shooting date and time.

The wireless communication unit 17 performs wireless communications with a partner device. In the present embodiment, the wireless communication unit 17 includes the high-speed wireless communication unit 18 capable of performing communications in a first mode in which the communication distance is short and high-speed and large-capacity communications are performed and the low-speed wireless communication unit 19 capable of performing communications in a second mode in which the transmission rate is lower than the high-speed wireless communication unit 18 and the communication distant is relatively long. The high-speed wireless communication unit 18 and the low-speed wireless communication unit 19 each include a transmission/reception circuit that transmits and receives a radio signal to and from a corresponding high-speed wireless communication unit or low-speed wireless communication unit of a partner device by a corresponding antenna 181 or antenna 191, and perform a demodulation process on a received signal and a modulation process on a transmission signal. The high-speed wireless communication unit 18 and the low-speed wireless communication unit 19 transmit a radio wave (communication signal) that notifies of presence thereof to perform the communication. Then, the high-speed wireless communication unit 18 and the low-speed wireless communication unit 19 each receive the radio wave transmitted from a corresponding wireless communication unit of the partner device to recover from the stopped state or the standby state and establish a communication with the partner device.

It is assumed that the high-speed wireless communication unit 18 performs non-contact proximity wireless communications capable of realizing a transmission rate of 375 Mbps or faster in the communication distance of about 3 cm as an example. With the proximity wireless communications realized by the high-speed wireless communication unit 18, all or part of data (image data) recorded in the digital camera 1 can be instantly transmitted to a partner device. In contrast, it is assumed that the low-speed wireless communication unit 19 performs wireless communications capable of realizing a transmission rate of a few Mbps in the communication distance of 10 cm or longer as an example. The high-speed wireless communication unit 18 and the low-speed wireless communication unit 19 can employ a communication device conforming to a communication standard capable of realizing a desired communication distance and a transmission rate.

The control unit 20 is constructed by a central processing unit (CPU) or the like. The control unit 20 reads the camera program from the recording unit 15 in accordance with an operation signal or the like from the operating unit 13 and executes it, and performs transfer of an instruction or data to each unit of the digital camera 1 and the like to collectively control the operation of the digital camera 1. The control unit 20 includes the communication control unit 21 and the transmission-remaining-amount judging unit 23 as a data amount judging unit.

The communication control unit 21 includes a communication switching control unit 211 and a communication state judging unit 215. The communication control unit 21 realizes communications with a partner device via the high-speed wireless communication unit 18 or the low-speed wireless communication unit 19 to control data transmission/reception. The communication switching control unit 211 controls switching between the communications with a partner device via the high-speed wireless communication unit 18 and the communications with a partner device via the low-speed wireless communication unit 19 in accordance with a content and a transmission remaining amount (transmission data amount) of data to be transmitted to the partner device, a current communication state, or the like. The communication switching control unit 211 includes a communication mode switching unit 213 that switches the communication mode during the communications by the low-speed wireless communication unit 19. Specifically, the communication mode switching unit 213 switches the communication mode between the constant communication mode in which the low-speed wireless communication unit 19 always transmits a radio wave to perform the communications continuously and the intermittent communication mode in which the low-speed wireless communication unit 19 perform the communications intermittently by transmitting a radio wave at predetermined time intervals (for example, every 1 second). The communication state judging unit 215 monitors and judges the communication state of the communications by the high-speed wireless communication unit 18 and the low-speed wireless communication unit 19. The transmission-remaining-amount judging unit 23 judges the transmission remaining amount of data to be transmitted to a partner device.

Next, a process procedure performed by the digital camera 1 is explained. FIG. 10 is a flowchart illustrating a procedure of a basic process performed by the digital camera 1. After the power is turned on, the digital camera 1 performs a process in accordance with the mode selected by a user's operation. Specifically, as shown in FIG. 10, when the currently-selected mode is the shooting mode (Yes at Step a1), the digital camera 1 performs the shooting mode process (Step a3). When the shooting mode process is finished, the system control proceeds to Step a9. When the current mode is not the shooting mode (No at Step a1) but is the playback mode (Yes at Step a5), the playback mode process is performed (Step a7). When the playback mode process is finished, the system control proceeds to Step a9. When the current mode is not the playback mode (No at Step a5), the system control also proceeds to Step a9. At Step a9, it is judged whether the basic process ends. For example, when power off is instructed by the operation of the button switches 7, the basic process ends (Yes at Step a9). Conversely, if the basic process does not end (No at Step a9), the system control returns to Step a1.

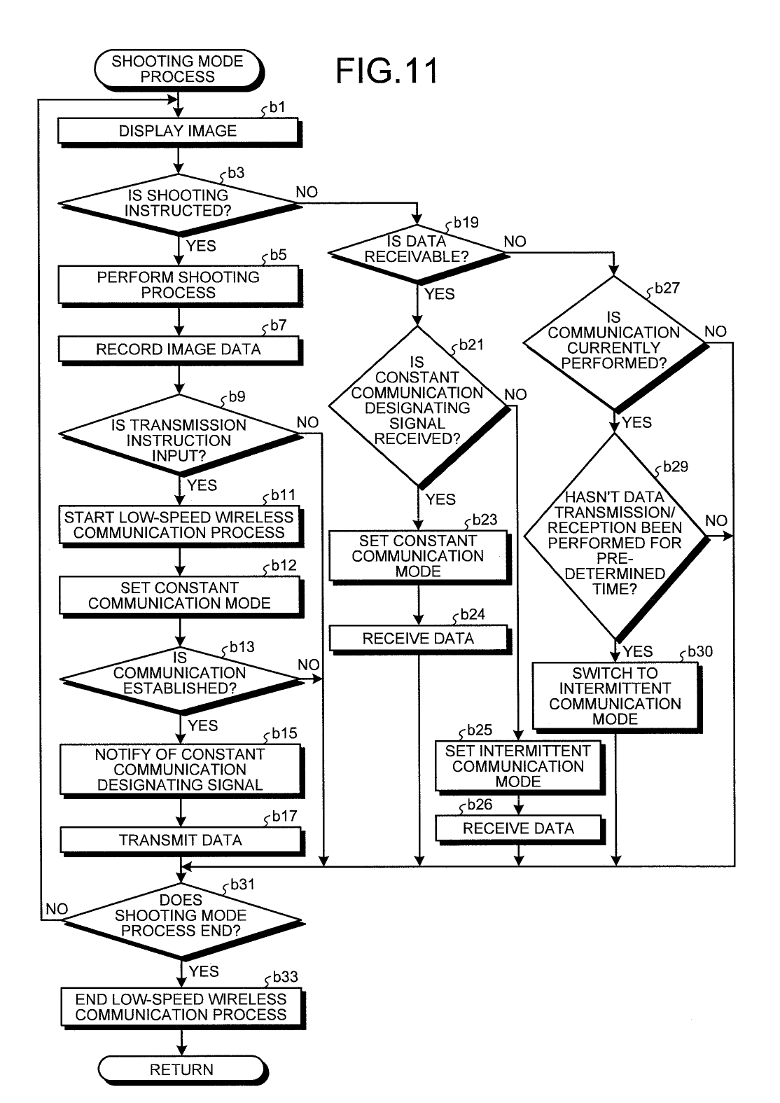

The shooting mode process at Step a3 and the playback mode process at Step a7 are sequentially explained. First, the shooting mode process is explained. FIG. 11 is a flowchart illustrating a detailed process procedure of the shooting mode process.

As shown in FIG. 11, in the shooting mode process, the control unit 20 first performs a process of starting the imaging unit 11 to capture an image and displaying the captured image on the display unit 14 as a live view image (Step b1). With this process, the live view image as a subject image focused on the imaging element can be updated and displayed for each frame.

When the release switch 5 is pressed to instruct shooting (Yes at Step b3), the shooting process is performed to generate image data of the captured image (Step b5) and the image data is recorded in the recording unit 15 with the captured image as a recorded image (Step b7).

At Step b9, it is judged whether a transmission instruction is input by a user. When the transmission instruction is input, for example, image data of the latest captured image generated in the shooting process at Step b5 is transmitted to a partner device with which the communication is established.

Specifically, when the transmission instruction is input (Yes at Step b9), the communication switching control unit 211 starts the low-speed wireless communication process (Step b11) and the communication mode switching unit 213 sets the constant communication mode (Step b12). With this process, the low-speed wireless communication unit 19 starts transmitting a radio wave continuously to perform the constant communication. When the low-speed wireless communication unit of the partner device receives the radio wave, the communication with the partner device is established.

For example, when the communication with the partner device is not established by the time a preset predetermined time has elapsed (No at Step b13), the system control proceeds to Step b31. When the communication with the partner device is established (Yes at Step b31), the communication switching control unit 211 performs a process of notifying the partner device of the constant communication designating signal via the low-speed wireless communication unit 19 (Step b15). The partner device that received the constant communication designating signal sets the constant communication mode as the communication mode of its low-speed wireless communication unit, so that thereafter, the digital camera 1 can communicate with the partner device with high response. The partner device is switched to the constant communication mode in such a manner considering a case in which the digital camera 1 captures images continuously and transmits the captured images continuously to the same partner device. In other words, if the low-speed wireless communication unit of the partner device is kept in the constant communication mode, the digital camera 1 can communicate with the partner device with high response in transmitting or receiving data thereafter.

Then, the communication switching control unit 211 transmits data (image data of the captured image captured at Step b5) to the partner device via the low-speed wireless communication unit 19 (Step b17) and then, the system control proceeds to Step b31.

When the shooting instruction is not input at Step b3 (No at Step b3), the communication switching control unit 211 judges whether data from the partner device is receivable. For example, the communication switching control unit 211 judges that the data is receivable when the communication is established with the partner device.

When the communication switching control unit 211 judges that data is receivable (Yes at Step b19) and the constant communication designating signal is received from the partner device (Yes at Step b21), the communication mode switching unit 213 sets the constant communication mode as the communication mode of the low-speed wireless communication unit 19 (Step b23). At this time, when the communication by the low-speed wireless communication unit 19 is not currently performed, the communication switching control unit 211 starts the low-speed wireless communication process. With this process, the low-speed wireless communication unit 19 continuously transmits a radio wave to perform the constant communication. Then, the communication switching control unit 211 receives the data transmitted from the partner device (Step b24) and thereafter, the system control proceeds to the Step b31.

In contrast, when the constant communication designating signal is not received (No at Step b21), the communication mode switching unit 213 sets the intermittent communication mode (Step b25). At this time, when the communication by the low-speed wireless communication unit 19 is not currently performed, the communication switching control unit 211 starts the low-speed wireless communication process. With this process, the low-speed wireless communication unit 19 intermittently transmits a radio wave to perform the intermittent communication. Then, the communication switching control unit 211 receives the data transmitted from the partner device (Step b26) and thereafter, the system control proceeds to the Step b31.

When the data is not receivable at Step b19 (No at Step b19), the communication switching control unit 211 judges whether the communication by the low-speed wireless communication unit 19 is currently performed. When the communication is currently performed (Yes at Step b27), the communication mode switching unit 213 judges whether a predetermined time has elapsed after the last data transmission/reception. When the predetermined time has not elapsed (No at Step b29), the system control proceeds to Step b31. Then, when the predetermined time has elapsed (Yes at Step b29), the communication mode switching unit 213 switches the communication mode of the low-speed wireless communication unit 19 to the intermittent communication mode (Step b30). At this time, when the communication mode of the low-speed wireless communication unit 19 is the intermittent communication mode, no particular process is performed. Thereafter, the system control proceeds to Step b31. When it is judged at Step b27 that the communication is not currently performed by the low-speed wireless communication unit 19 (No at Step b27), the system control proceeds to Step b31.

At Step b31, the control unit 20 judges whether to end the shooting mode. When the control unit 20 judges to end the shooting mode (Yes at Step b31), the system control proceeds to Step b33. When the control unit 20 judges not to end the shooting mode (No at Step b31), the system control returns to Step b1.

Then, at Step b33, the communication switching control unit 211 stops the transmission of the radio wave from the low-speed wireless communication unit 19 by ending the low-speed wireless communication process to end the communication currently performed by the low-speed wireless communication unit 19. At this time, when the communication by the low-speed wireless communication unit 19 is not currently performed, no particular process is performed. Thereafter, the system control returns to Step a3 in FIG. 10.

In this manner, in the present embodiment, when the communication by the low-speed wireless communication unit 19 is started during the shooting mode, the communication state is maintained until the end of the shooting mode. Then, time is counted from the last data transmission/reception with any partner device, and the communication mode of the low-speed wireless communication unit 19 is switched to the intermittent communication mode when the predetermined time has elapsed. The configuration can be such that the low-speed wireless communication process ends when the predetermined time has elapsed and the transmission of a radio wave from the low-speed wireless communication unit 19 is stopped. At this time, it is possible to perform a process of displaying a message that data transmission/reception is not performed for the predetermined time on the display unit 14 as an alarm. Alternatively, a warning alarm can be output from a speaker (not shown).

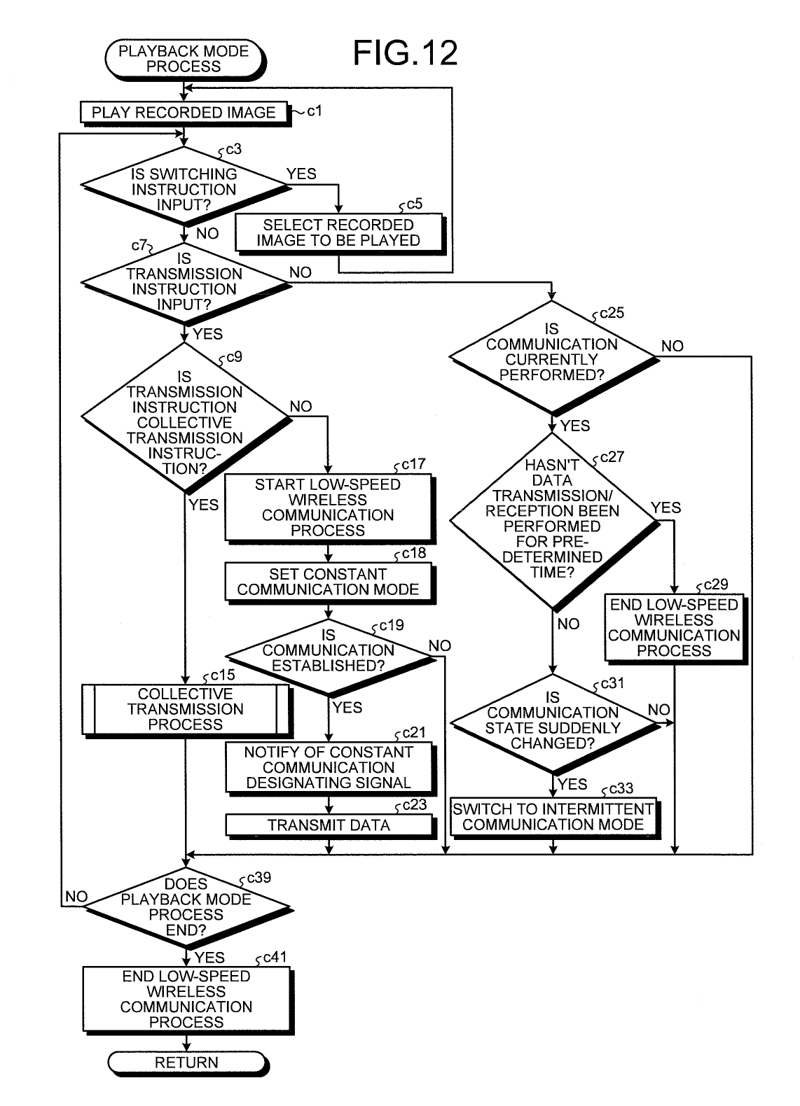

Next, the playback mode process is explained. FIG. 12 is a flowchart illustrating a detailed process procedure of the playback mode process. As shown in FIG. 12, in the playback mode process, the control unit 20 performs a process of sequentially reading and playing (displaying) images recorded in the recording unit 15 (Step c1). The recorded images can be played, for example, by reading image data of the recorded images one by one in order of shooting and displaying it. Alternatively, thumbnail data of the recorded images can be read and displayed on a list and image data of a recorded image selected from the list by a user's operation can be displayed. The recorded images to be played include one recorded in the recording unit 15 after being captured by the digital camera 1 and image data received from the partner device at Step b24 or b25 in FIG. 11.

When a switching instruction for a recorded image being played is input (Yes at Step c3), the control unit 20 selects a recorded image to be played (Step c5) and the system control returns to Step c1.

When the switching instruction for the recorded image being played is not input (No at Step c3), the system control proceeds to Step c7. At Step c7, it is judged whether a transmission instruction is input by a user. When the transmission instruction is input, for example, image data of the recorded image selected from the recorded images played at Step c1 is transmitted to the partner device with which the communication is established.

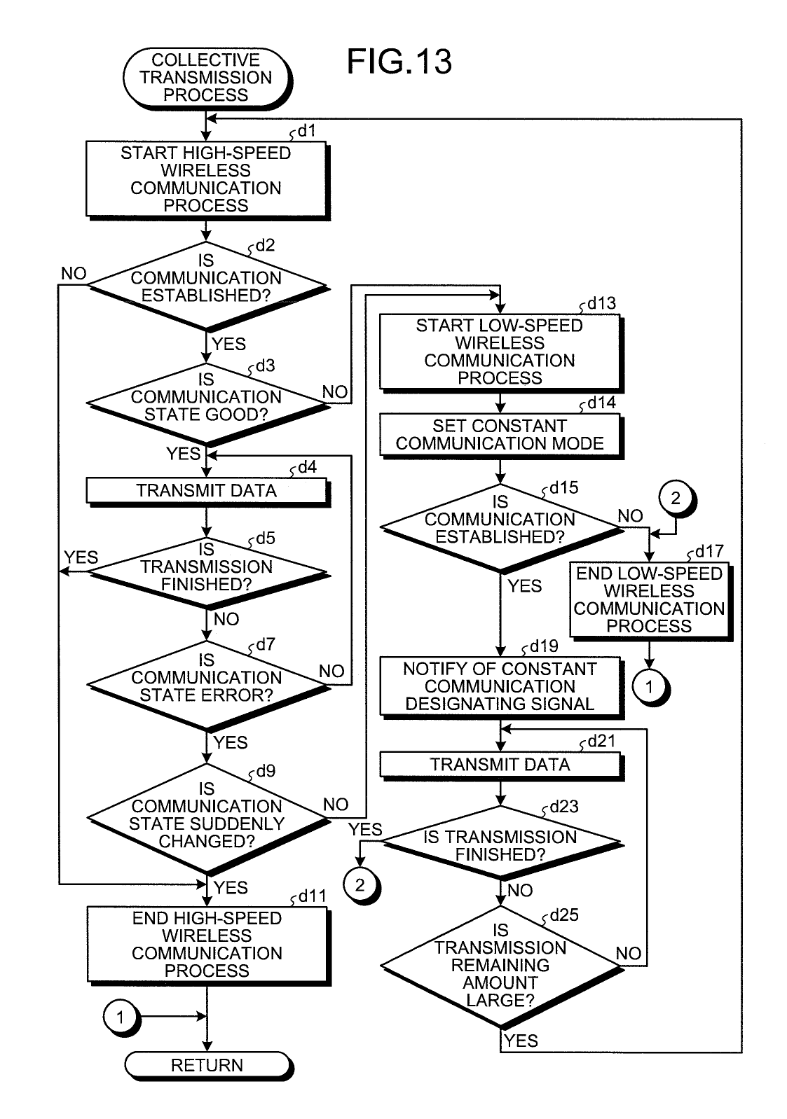

Specifically, when the transmission instruction is input (Yes at Step c7), the communication switching control unit 211 first judges the input transmission instruction. Specifically, the communication switching control unit 211 judges whether the transmission instruction is a transmission instruction for collectively transmitting a plurality of recorded images in the recording unit 15 or a transmission instruction for transmitting the recorded images in the recording unit 15 one by one. When the transmission instruction is the collective transmission instruction (Yes at Step c9), the system control proceeds to a collective transmission process (Step c15). FIG. 13 is a flowchart illustrating a detailed process procedure of the collective transmission process.

As shown in FIG. 13, in the collective transmission process, first, the communication switching control unit 211 controls to switch to the communication by the high-speed wireless communication unit 18 and starts the high-speed wireless communication process (Step d1). With this process, the high-speed wireless communication unit 18 starts transmitting a radio wave. When the high-speed wireless communication unit of the partner device receives the radio wave, the communication with the partner device is established.

For example, when the communication with the partner device is not established by the time a preset predetermined time has elapsed (No at Step d2), the system control proceeds to Step d11. In other words, at Step d11, the communication switching control unit 211 stops the transmission of the radio wave from the high-speed wireless communication unit 18 by ending the high-speed wireless communication process to end the communication currently performed by the high-speed wireless communication unit 18. Then, the system control returns to Step c15 in FIG. 12, and thereafter proceeds to Step c39.

When the communication with the partner device is established (Yes at Step d2), the communication state judging unit 215 judges the communication state of the communication by the high-speed wireless communication unit 18. For example, the communication state judging unit 215 performs a process of notifying the partner device of a predetermined signal and judges whether the communication state is good based on a content of a response signal notified from the partner device in response thereto, a response time, and the like. When it is judged that the communication state is good (Yes at Step d3), the communication switching control unit 211 performs a process of transmitting data (image data of a plurality of recorded images that is instructed to transmit collectively) to the partner device via the high-speed wireless communication unit 18 (Step d4). Then, when the transmission is finished (Yes at Step d5), the system control proceeds to Step d11, and the communication switching control unit 211 stops the transmission of the radio wave from the high-speed wireless communication unit 18 by ending the high-speed wireless communication process to end the communication currently performed by the high-speed wireless communication unit 18. Then, the system control returns to Step c15 in FIG. 12, and thereafter proceeds to Step c39.

In contrast, when the transmission is not finished (No at Step d5), the communication state judging unit 215 monitors the communication state of the communication by the high-speed wireless communication unit 18. When the communication state is good and an error does not occur (No at Step d7), the system control returns to Step d4 for sequentially transmitting unsent data. The error occurs, for example, when the communication state becomes unstable due to displacement between the antennas of the high-speed wireless communication unit 18 and the high-speed wireless communication unit of the partner device positioned close to each other, or the like, in addition to disturbances. Then, when the communication state becomes unstable and an error occurs (Yes at Step d7), the communication state judging unit 215 judges whether the communication state is suddenly changed. The sudden change of the communication state means a case that the communication state suddenly deteriorates such as a case that the communication is cut off because the partner device is suddenly moved away from the digital camera 1 during data transmission. In such a case, it is regarded that a user cancels the data transmission. In other words, when the communication state suddenly deteriorates and an error occurs (Yes at Step d9), the system control proceeds to Step d11 and the communication switching control unit 211 stops the transmission of the radio wave from the high-speed wireless communication unit 18 by ending the high-speed wireless communication process to end the communication currently performed by the high-speed wireless communication unit 18. Then, the system control returns to Step c15 in FIG. 12, and thereafter proceeds to Step c39.

When it is judged at Step d3 that the communication state is not good (No at Step d3), the system control proceeds to Step d13. When it is judged at Step d7 that an error occurs (Yes at Step d7) and it is judged at Step d9 that the communication state is not suddenly changed (No at Step d9), the system control proceeds to Step d13.

In other words, the communication switching control unit 211 controls to switch to the communication by the low-speed wireless communication unit 19 and starts the low-speed wireless communication process (Step d13), and the communication mode switching unit 213 sets the constant communication mode (Step d14). Then, for example, when the communication with the partner device is not established by the time a preset predetermined time has elapsed (No at Step d15), the system control proceeds to Step d17. In other words, the communication switching control unit 211 stops the transmission of the radio wave from the low-speed wireless communication unit 19 by ending the low-speed wireless communication process to end the communication currently performed by the low-speed wireless communication unit 19 (Step d17). Then, the system control returns to Step c15 in FIG. 12, and thereafter proceeds to Step c39.

In contrast, when the communication with the partner device is established (Yes at Step d15), the communication switching control unit 211 performs a process of notifying the partner device of the constant communication designating signal via the low-speed wireless communication unit 19 (Step d19). Then, the communication switching control unit 211 performs a process of transmitting data (unsent image data of a plurality of recorded images that is instructed to transmit collectively) to the partner device via the low-speed wireless communication unit 19 (Step d21). Then, when the transmission is finished (Yes at Step d23), the system control proceeds to Step d17, and the communication switching control unit 211 stops the transmission of the radio wave from the low-speed wireless communication unit 19 by ending the low-speed wireless communication process to end the communication currently performed by the low-speed wireless communication unit 19. Then, the system control returns to Step c15 in FIG. 12, and thereafter proceeds to Step c39.

When the transmission is not finished (No at Step d23), the transmission-remaining-amount judging unit 23 judges the transmission remaining amount of the data. For example, the transmission-remaining-amount judging unit 23 judges the magnitude of the transmission remaining amount by performing a threshold process on the unsent data amount to be transmitted to the partner device. When the transmission remaining amount is large (Yes at Step d25), the system control returns to Step d1. With this process, when the transmission remaining amount of data is large, the communication is switched to the communication by the high-speed wireless communication unit 18. Then, when the communication state is good, the unsent data is transmitted to the partner device via the high-speed wireless communication unit 18. When the transmission remaining amount is small (No at Step d25), the system control returns to Step d21. With this process, when the transmission remaining amount of data is small, the unsent data is directly transmitted to the partner device via the low-speed wireless communication unit 19.

As shown in FIG. 12, when the transmission instruction judged at Step c7 is not the collective transmission instruction but the transmission instruction for transmitting the recorded images one by one (No at Step c9), the system control proceeds to Step c17. In other words, the communication switching control unit 211 controls to switch to the communication by the low-speed wireless communication unit 19 and starts the low-speed wireless communication process (Step c17), and the communication mode switching unit 213 sets the constant communication mode (Step c18). Then, for example, when the communication with the partner device is not established by the time a preset predetermined time has elapsed (No at Step c19), the system control proceeds to Step c39. When the communication with the partner device is established (Yes at Step c19), the communication switching control unit 211 performs a process of notifying the partner device of the constant communication designating signal via the low-speed wireless communication unit 19 (Step c21). Then, the communication switching control unit 211 transmits data (image data of the recorded images that are instructed to transmit one by one) to the partner device via the low-speed wireless communication unit 19 (Step c23), and thereafter the system control proceeds to Step c39.

When the transmission instruction is not input at Step c7 (No at Step c7), the communication switching control unit 211 judges whether the communication by the low-speed wireless communication unit 19 is currently performed. When the communication by the low-speed wireless communication unit 19 is currently performed (Yes at Step c25), the communication mode switching unit 213 judges whether a predetermined time has elapsed after the last data transmission/reception. When the predetermined time has elapsed (Yes at Step c27), the communication switching control unit 211 stops the transmission of the radio wave from the low-speed wireless communication unit 19 by ending the low-speed wireless communication process to end the communication currently performed by the low-speed wireless communication unit 19 (Step c29). Thereafter, the system control proceeds to Step c39.

In contrast, when the predetermined time has not elapsed (No at Step c27), the communication state judging unit 215 monitors a case of a sudden change of the communication state based on a change of the communication state of the communication by the low-speed wireless communication unit 19. The sudden change of the communication state means a case that the communication state suddenly deteriorates in the similar manner to Step d9 in FIG. 13. When the communication state suddenly deteriorates and an error occurs (Yes at Step c31), the communication mode switching unit 213 switches the communication mode of the low-speed wireless communication unit 19 to the intermittent communication mode (Step c33). At this time, when the communication mode of the low-speed wireless communication unit 19 is the intermittent communication mode, no particular process is performed. Thereafter, the system control proceeds to Step c39. When it is judged at Step c25 that the communication by the low-speed wireless communication unit 19 is not currently performed (No at Step c25), the system control also proceeds to Step c39.

Then, at Step c39, the control unit 20 judges whether to end the playback mode. When the control unit 20 judges to end the playback mode (Yes at Step c39), the system control proceeds to Step c41. When the control unit 20 judges not to end the playback mode (No at Step c39), the system control returns to Step c3.

Then, at Step c41, the communication switching control unit 211 stops the transmission of the radio wave from the low-speed wireless communication unit 19 by ending the low-speed wireless communication process to end the communication currently performed by the low-speed wireless communication unit 19. At this time, when the communication by the low-speed wireless communication unit 19 is not currently performed, no particular process is performed. Thereafter, the system control returns to Step a7 in FIG. 10.

In this manner, in the present embodiment, when the collective transmission is instructed during the playback mode, first, the communication by the high-speed wireless communication unit 18 is performed to transmit image data to a partner device. When the communication state of the communication by the high-speed wireless communication unit 18 is not good, the communication is switched to the communication by the low-speed wireless communication unit 19 to transmit the image data to the partner device. In contrast, when the instruction for transmitting the recorded images one by one during the playback mode is input and the communication by the low-speed wireless communication unit 19 is started, time is counted after the last data transmission/reception with any partner device and the communication state is maintained until a predetermined time has elapsed. Furthermore, the communication state of the communication by the low-speed wireless communication unit 19 is monitored until the predetermined time has elapsed to judge the case that the communication state is suddenly changed to deteriorate, and the communication mode of the low-speed wireless communication unit 19 is switched to the intermittent communication mode.

As described above, according to the present embodiment, when the instruction for collectively transmitting a plurality of pieces of image data is input (when the usage state of the digital camera 1 is the usage state in which a stationary device is used as a portable device and it is considered that the transmission data amount is large), the communication by the high-speed wireless communication unit 18 can be performed to transmit the data to the partner device. In contrast, when the instruction for transmitting image data for one image is input (when the usage state of the digital camera 1 is the usage state in which a portable-type device is used as a portable device or the usage state in which a stationary device is used as a portable device and it is considered that the transmission data amount is small), the communication by the low-speed wireless communication unit 19 can be performed to transmit the data to the partner device. Then, the communication state of the communication by the high-speed wireless communication unit 18 is judged. When the communication state is not good, the communication can be switched to the communication by the low-speed wireless communication unit 19 to transmit the data. Accordingly, the data transmission can be performed while appropriately switching the communication between the communication by the high-speed wireless communication unit 18 and the communication by the low-speed wireless communication unit 19. Thus, the data transmission/reception with the partner device can be easily and surely performed.

Moreover, the communication mode of the low-speed wireless communication unit 19 can be switched during the communication by the low-speed wireless communication unit 19 in accordance with a change of the communication state or the elapsed time after the last data transmission/reception with the partner device. Thus, power consumption by the communication with the partner device can be reduced.

The preferred embodiment of the present invention has been explained; however, the present invention is not limited to the above embodiment and can be appropriately changed within the scope of the invention.

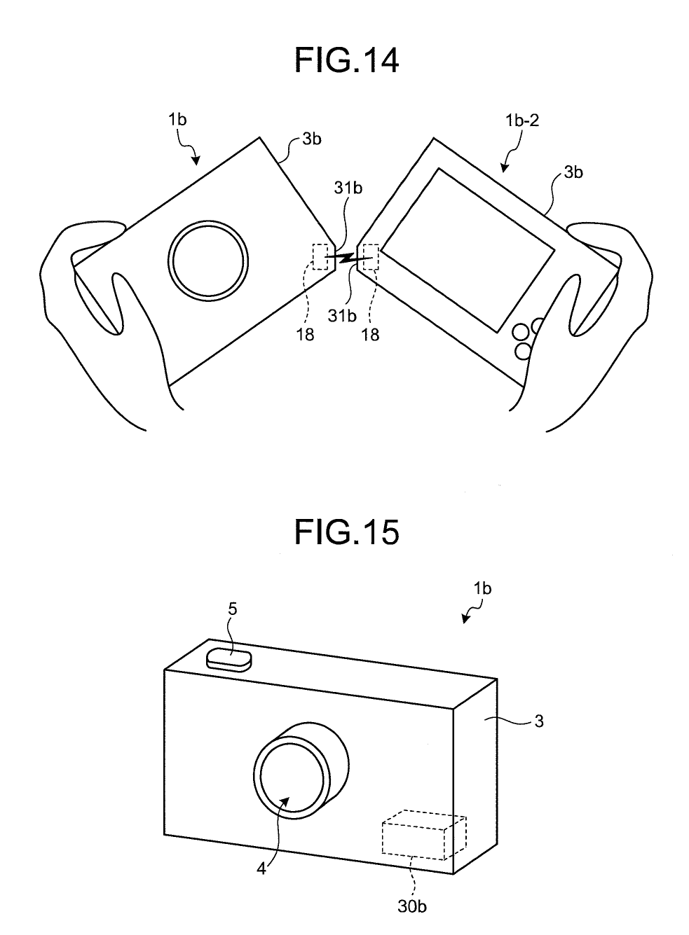

FIG. 14 is a schematic diagram illustrating a state in which a digital camera 1b of a modified example communicates with another digital camera 1b-2 as a partner device. As shown in FIG. 14, an inclined surface 31b can be formed at one corner on the bottom surface side of a camera body 3b, and the high-speed wireless communication unit 18 can be incorporated so that an antenna thereof is arranged on the side of the inclined surface 31b. With this configuration, when communicating with the digital camera 1b-2 as a partner device, the digital camera 1b and the digital camera 1b-2 can be easily positioned close to each other by causing the inclined surfaces 31b thereof to face to each other. Therefore, the operability in communication is improved and communication failure due to displacement can be further suppressed. In FIG. 14, the low-speed wireless communication unit 19 is not shown; however is arranged at an appropriate position in the camera body 3b.

In the above embodiment, the communication is switched to the communication by the high-speed wireless communication unit 18 when the collective transmission is instructed and to the communication by the low-speed wireless communication unit 19 when the transmission of image data one by one is instructed during the playback mode. Alternatively, the magnitude of data amount to be actually transmitted can be judged according to the transmission instruction. When it is judged that the data amount is large, the communication can be switched to the communication by the high-speed wireless communication unit 18. When it is judged that the data amount is small, the communication can be switched to the communication by the low-speed wireless communication unit 19.

Moreover, in the above embodiment, when the communication is cut off during transmission of data, it is judged that the communication state is suddenly changed; however, it is also possible to judge the intensity of the received radio wave and judge whether the communication state is suddenly changed based on a change of the intensity.

Alternatively, the threshold process can be performed on the displacement rate of the camera body 3 when the communication is cut off. When the communication is cut off because the camera body 3 is moved at a speed faster than a predetermined reference speed (when the digital camera 1 is quickly moved away from a partner device), it is possible to judge that the communication state is suddenly changed. In this case, a displacement detecting unit for detecting the displacement rate is provided to the digital camera 1, and the displacement of the camera body 3 during the communication is detected by the displacement detecting unit. For example, the displacement detecting unit can be composed of a known acceleration sensor for detecting an acceleration of the camera body 3 or a known angular velocity sensor for detecting an angular velocity of the camera body 3 when the camera body 3 rotates.

Furthermore, in the above embodiment, the communication mode of the low-speed wireless communication unit 19 is set by switching between the constant communication mode and the intermittent communication mode. In the similar manner, the communication mode of the high-speed wireless communication unit 18 can be set by switching between the constant communication mode and the intermittent communication mode. For example, the communication mode when the communication by the high-speed wireless communication unit 18 is started at Step d1 in FIG. 13 is set to the constant communication mode. Then, after the data transmission at Step d4 in FIG. 13, the communication mode can be switched to the intermittent communication mode. Then, for example, the communication by the high-speed wireless communication unit 18 can end when a predetermined time has elapsed after the last data transmission/reception with a partner device.

Moreover, in the above embodiment, the digital camera 1 includes the high-speed wireless communication unit 18 and the low-speed wireless communication unit 19 as an example; however, two or more communication devices having different transmission rates or communication distances can be appropriately combined. For example, as the high-speed wireless communication unit 18 or the low-speed wireless communication unit 19, a communication device using a non-contact proximity wireless communication by the electromagnetic induction method or an infrared communication, or conforming to various communication standards such as the Bluetooth (registered trademark) or a wireless local area network (LAN) standard can be appropriately employed. It is also possible to perform control such as changing a modulating frequency according to the transmission remaining amount of data.

Furthermore, in the above embodiment, the wireless communication unit 17 is configured by combining individual hardware having different transmission rates and communication distances as the high-speed wireless communication unit 18 and the low-speed wireless communication unit 19; however, it is not limited thereto.

FIG. 15 is a schematic perspective view showing a front surface side of the digital camera 1b of the modified example. As shown in FIG. 15, a wireless communication unit 30b for performing a wireless communication with a partner device as an external device such as the digital camera 1, a PC, a cellular phone, or a television set is incorporated at one corner portion on the bottom surface side in the camera body 3 in the digital camera 1b.

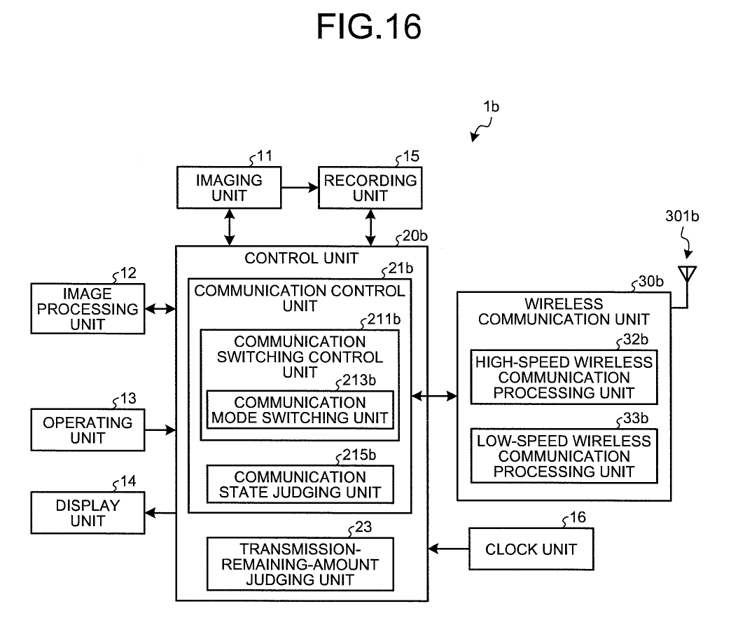

FIG. 16 is a block diagram illustrating an example of an internal configuration of a relevant portion of the digital camera 1b. In FIG. 16, components that are the same as those in the above embodiment are given the same reference numerals. As shown in FIG. 16, the digital camera 1b includes the imaging unit 11, the image processing unit 12, the operating unit 13, the display unit 14, the recording unit 15, the clock unit 16, the wireless communication unit 30b, and a control unit 20b.

The wireless communication unit 30b performs a wireless communication with a partner device. The wireless communication unit 30b includes a transmission/reception circuit that transmits and receives a radio signal to and from the wireless communication unit of the partner device by an antenna 301b, and performs a demodulation process on the received signal and a modulation process on the transmission signal. The wireless communication unit 30b transmits a radio wave that notifies of the presence thereof to perform a communication, and receives a radio wave transmitted from a corresponding wireless communication unit of the partner device to recover from the stopped state or the standby state and establish the communication with the partner device.

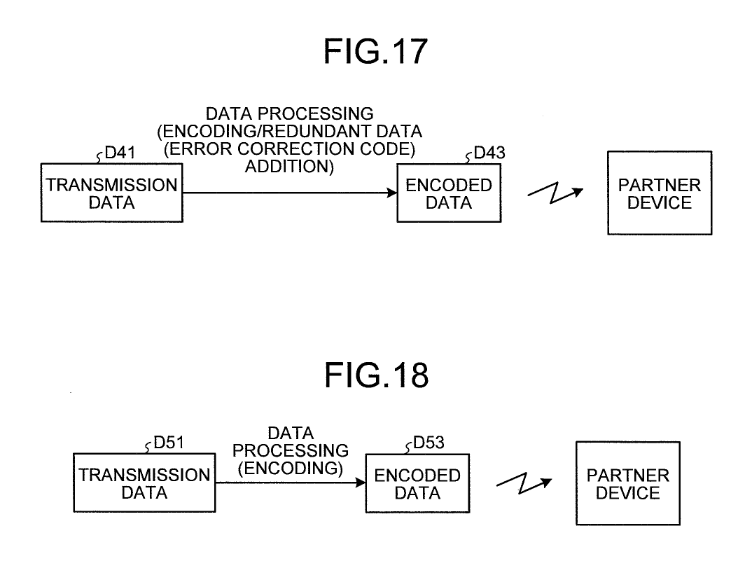

The wireless communication unit 30b includes a high-speed wireless communication processing unit 32b as a first wireless communication processing unit for performing a high-speed wireless communication process and a low-speed wireless communication processing unit 33b as a second wireless communication processing unit for performing a low-speed wireless communication process. FIG. 17 is a schematic diagram explaining a principle of the low-speed wireless communication process performed by the low-speed wireless communication processing unit 33b, and FIG. 18 is a schematic diagram explaining a principle of the high-speed wireless communication process performed by the high-speed wireless communication processing unit 32b. As shown in FIG. 17, the low-speed wireless communication processing unit 33b performs data processing on data (transmission data) D41 as a transmission target and adds redundant data (error correction code) for error correction to generate encoded data D43. Then, the low-speed wireless communication processing unit 33b performs a process of transmitting the generated encoded data D43 to a partner device via the antenna 301b. In contrast, as shown in FIG. 18, the high-speed wireless communication processing unit 32b encodes transmission data D51 to generate encoded data D53 and performs a process of transmitting the generated encoded data D51 to a partner device via the antenna 301b.

In the modified example, the control unit 20b includes a communication control unit 21b and the transmission-remaining-amount judging unit 23. The communication control unit 21b includes a communication switching control unit 211b and a communication state judging unit 215b. The communication control unit 21b realizes a communication with a partner device via the wireless communication unit 30b to control data transmission/reception.

The communication switching control unit 211b controls switching between the communication via the high-speed wireless communication processing unit 32b and the communication via the low-speed wireless communication processing unit 33b in accordance with a content and a transmission remaining amount (transmission data amount) of data to be transmitted to a partner device, a current communication state, or the like. Specifically, in the similar manner to the above embodiment, the communication switching control unit 211b switches to the high-speed wireless communication process by the high-speed wireless communication processing unit 32b when it is instructed to collectively transmit a plurality of pieces of image data. In contrast, when it is instructed to transmit image data for one image, or when the communication state of the communication in the high-speed wireless communication process is not good, the communication switching control unit 211b switches to the low-speed wireless communication process by the low-speed wireless communication processing unit 33b.

The communication switching control unit 211b includes a communication mode switching unit 213a that switches the communication mode at least during the communication via the low-speed wireless communication processing unit 33b. Specifically, a communication mode switching unit 213b switches the communication mode between the constant communication mode and the intermittent communication mode in the similar manner to the above embodiment during the low-speed wireless communication process. The constant communication mode is a communication mode in which a radio wave is always transmitted from the antenna 301b to perform the communication continuously. The intermittent communication mode is a communication mode in which a radio wave is transmitted intermittently at a predetermined time interval (for example, every 1 second) to perform the communication intermittently. The communication mode of the communication via the high-speed wireless communication processing unit 32b can also be switched between the constant communication mode and the intermittent communication mode.

The communication state judging unit 215b monitors and judges the communication state of the communications via the high-speed wireless communication processing unit 32b and the low-speed wireless communication processing unit 33b.

According to the modified example, the communication process to be performed in the communication can be performed while switching between the high-speed wireless communication process by the high-speed wireless communication processing unit 32b and the low-speed wireless communication process by the low-speed wireless communication processing unit 33b. When the communication switching control unit 211b switches to the low-speed wireless communication process by the low-speed wireless communication processing unit 33b, transmission data can be transmitted to a partner device after adding redundant data thereto. The partner device on the reception side can restore the transmission data by performing the error correction, so that it is possible to improve reliability of data to be transmitted in the communication by the low-speed wireless communication processing unit 33b. Thus, the data transmission/reception with the partner device can be easily and surely performed and therefore the effects similar to the above embodiment can be achieved.

In the above embodiment, a digital camera is employed as one example of the portable device in the present invention; however, the present invention can be applied to other portable devices capable of transmitting/receiving data to/from an external device, such as a cellular phone having a camera function, a game console, a music player, and a recording device. For example, in a portable music player as an example of the portable device, the present invention can be applied in a case of transmitting/receiving music data to/from an external device. Moreover, in the portable music player, the present invention can be applied in a case of transmitting/receiving music data and data related to the music data such as image data of a compact disc jacket. Alternatively, in the recording device as an example of the portable device, the present invention can be applied in a case of transmitting/receiving recorded data to/from an external device.

According to an aspect of the present invention, it is possible to switch the communication between the communication with an external device via a first wireless communication unit and the communication with the external device via a second wireless communication unit based on the communication state of the communication with the external device via the first wireless communication unit and/or the second wireless communication unit or a transmission data amount to be transmitted to the external device. Therefore, the data transmission to the external device can be performed while appropriately switching between the first wireless communication unit and the second wireless communication unit having different communication distances and communication rates, so that the data transmission/reception with the external device can be easily and surely performed. Moreover, it is possible to switch the communication between the communication with the external device via the first wireless communication processing unit and the communication with the external device via the second wireless communication processing unit based on the communication state of the communication with the external device via the first wireless communication processing unit and/or the second wireless communication processing unit or a transmission data amount to be transmitted to the external device. Therefore, the data transmission to the external device can be performed while appropriately switching between the first wireless communication processing unit and the second wireless communication processing unit, so that the data transmission/reception with the external device can be easily and surely performed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable device comprising:
a first wireless communication unit of which communication distance is short, the first wireless communication unit being capable of performing high-speed communications;
a second wireless communication unit of which communication distance is long compared with the first wireless communication unit, the second wireless communication unit being capable of performing low-speed communications;
a communication control unit that performs communications with an external device via any one of the first wireless communication unit and the second wireless communication unit and controls at least a transmission of data to the external device; and
a communication state judging unit that judges a communication state of the communications with the external device via any one of the first wireless communication unit and the second wireless communication unit, wherein
the communication control unit performs switching between the communications with the external device via the first wireless communication unit and the communications with the external device via the second wireless communication unit based on at least one of the communication state judged by the communication state judging unit and a transmission data amount to be transmitted to the external device in order to control the transmission of data to the external device.

2. The portable device according to claim 1, further comprising a communication mode switching unit that switches at least a communication mode of the second wireless communication unit between a constant communication mode, in which a communication is always performed continuously, and an intermittent communication mode, in which a communication is performed intermittently, wherein
the communication mode switching unit switches the communication mode between the constant communication mode and the intermittent communication mode in accordance with the communication state with the external device via the second wireless communication unit judged by the communication state judging unit during the communications with the external device via the second wireless communication unit.

3. The portable device according to claim 1, further comprising a data amount judging unit that judges the transmission data amount, wherein
when the data amount judging unit judges that the transmission data amount is large and the communication state judging unit judges that the communication state via the first wireless communication unit is good, the communication control unit controls the communications with the external device via the first wireless communication unit.

4. The portable device according to claim 3, wherein when the data amount judging unit judges that the transmission data amount is large and the communication state judging unit judges that the communication state via the first wireless communication unit is not good or when the data amount judging unit judges that the transmission data amount is small, the communication control unit controls the communications with the external device via the second wireless communication unit.

5. The portable device according to claim 1, wherein an antenna of at least the first wireless communication unit is arranged at a corner portion of a casing of the portable device.

6. A portable device comprising:
a wireless communication unit that comprises
a first wireless communication processing unit of which communication distance is short, the first wireless communication unit being capable of performing high-speed communications and
a second wireless communication processing unit of which communication distance is long compared with the first wireless communication unit, the second wireless communication unit being capable of performing low-speed communications;
a communication control unit that performs communications with an external device via any one of the first wireless communication processing unit and the second wireless communication processing unit and controls at least a transmission of data to the external device; and
a communication state judging unit that judges a communication state of the communications with the external device via any one of the first wireless communication processing unit and the second wireless communication processing unit, wherein
the communication control unit performs switching between the communications with the external device via the first wireless communication processing unit and the communications with the external device via the second wireless communication processing unit based on at least one of the communication state judged by the communication state judging unit and a transmission data amount to be transmitted to the external device in order to control the transmission of data to the external device.

7. The portable device according to claim 6, further comprising a communication mode switching unit that switches at least a communication mode via the second wireless communication processing unit between a constant communication mode, in which a communication is always performed continuously, and an intermittent communication mode, in which a communication is performed intermittently, wherein
the communication mode switching unit switches the communication mode between the constant communication mode and the intermittent communication mode in accordance with the communication state with the external device via the second wireless communication processing unit judged by the communication state judging unit during the communications with the external device via the second wireless communication processing unit.

8. The portable device according to claim 6, further comprising a data amount judging unit that judges the transmission data amount, wherein
when the data amount judging unit judges that the transmission data amount is large and the communication state judging unit judges that the communication state via the first wireless communication processing unit is good, the communication control unit controls the communications with the external device via the first wireless communication processing unit.

9. The portable device according to claim 8, wherein when the data amount judging unit judges that the transmission data amount is large and the communication state judging unit judges that the communication state via the first wireless communication processing unit is not good or when the data amount judging unit judges that the transmission data amount is small, the communication control unit controls the communications with the external device via the second wireless communication processing unit.

10. The portable device according to claim 6, wherein an antenna of the wireless communication unit is arranged at a corner portion of a casing of the portable device.

11. A portable device comprising:
a wireless communication unit that performs a data transmission and reception with an external device that is brought to close to the portable device; and
a communication control unit that performs a communication with the external device via the wireless communication unit and controls at least a transmission of data to the external device, wherein
the wireless communication unit includes a first communication mode, in which a communication distance is short and high-speed communications are performed, and a second communication mode, in which a communication distance is long and low-speed communications are performed, and
the communication control unit switches a communication mode between the first communication mode and the second communication mode based on a usage state of the portable device.

12. The portable device according to claim 11, wherein the communication control unit, when the usage state is such that the portable device performs communications with a stationary device as the external device, performs the communications with the external device by switching to any one of the first communication mode and the second communication mode in accordance with a transmission data amount to be transmitted to the external device, and, when the usage state is such that the portable device performs communications with a portable-type device as the external device, performs the communications with the external device by switching to the second communication mode.
